(19) United States
(12) Patent Application Publication
(10) Pub. No.: US 2009/0264018 A1
(43) Pub. Date: Oct. 22, 2009

(54) Connector System and Contact Element for Such a System

(76) Inventors: Ronald C. Weber, Olsterwijk (NL); Gert Droesbeke, Geel (BE)

Correspondence Address: Harrington & Smith PC, 4 Research Drive, Suite 202, Shelton, CT, 06484, US

(21) Appl. No.: 11/883,971

(22) PCT Filed: Feb. 8, 2005
(86) PCT No.: PCT/EP05/02368

§ 371 Date: Sep. 22, 2008

(51) Int. Cl. H01R 13/648

(52) U.S. Cl. 439/607.17; 439/607.01

(57) ABSTRACT

The invention relates a connector system including a connector housing, capable of receiving a cable connector, and a panel, said panel having at least one opening defined by edges of said panel, from which opening at least a front portion of said connector housing protrudes to receive said cable connector and wherein at least one contact element is provided, capable of electrically coupling said connector housing and said cable connector by a first group of electrical contacts and electrically coupling said connector housing and said panel by a second group of electrical contacts. The contact element is structured to provide at least two contacts for said second group. The invention also relates to a contact element as such.

The invention relates to a connector system comprising a connector housing, capable of receiving a cable connector, and a panel, said panel having at least one opening defined by edges of said panel, from which opening at least a front portion of said connector housing protrudes to receive said cable connector and wherein at least one contact element is provided, capable of electrically coupling said connector housing and said cable connector by a first group of electrical contacts and electrically coupling said connector housing and said panel by a second group of electrical contacts.

WO 2004/112199 discloses a shielding cage, capable of receiving a cable connector, extending along a longitudinal axis between a front side and a rear side and comprising a diecast metal section extending from said front side over a first length along said longitudinal axis. The shielding cage contains a sheet metal section extending from said rear side towards said front side over a second length along said longitudinal axis. The diecast metal section partly protrudes through an opening of a panel and comprises-metal springs that are bend towards and away from the longitudinal axis for respectively contacting the cable connector and the panel to obtain adequate electromagnetic shielding.

It is an object of the present invention to provide a connector system with an improved electromagnetic shielding performance.

This object is accomplished by providing a connector system characterized in that said contact element is structured to provide at least two separate electrical contacts for said second portion.

Investigations and prototyping of the prior art connector system has taught that the main function of the first group of electrical contacts, i.e. the inner contacts of the connector housing for contacting the cable connector, is to carry leakage currents. The second group of electrical contacts, i.e. the outer contacts on the connector housing for contacting the panel, is more relevant for the electromagnetic shielding performance of the connector system. The second group of electrical contacts provides a number of contact points between the connector housing and the panel to improve electromagnetic shielding by optimally closing spaces between the housing and panel. Consequently, e.g. a slit between the connector housing and the edges of the panel as a result of e.g. an alignment tolerance may be substantially or partly closed by the second group of electrical contacts.

It should be acknowledged that the electrical contacts of the first and/or second group may be point contacts, line contacts, planar contacts etc. and at least the second group of contacts comprises at least two of such contacts separated from each other by a non-contact area.

Preferably, the contact element is capable of providing spring force action against at least one of the cable connector and the edges of the panel. Such an embodiment may guarantee an adequate contact force and accordingly provides a more robust connector system.

Advantageous embodiments are defined in the dependent claims and will be further described in the specification.

The invention also relates to a contact element comprising a first portion and a second portion coupled via at least one bended portion, defining a first group of electrical contacts for said first portion and a second group of electrical contacts, wherein said contact element is structured to provide at least two separate electrical contacts for said second portion.

Such a contact element can be advantageously applied in a connector system as described above.

The invention will be further illustrated with reference to the attached drawings, which schematically show preferred embodiments according to the invention. It will be understood that the invention is not in any way restricted to these specific and preferred embodiments.

In the drawings:

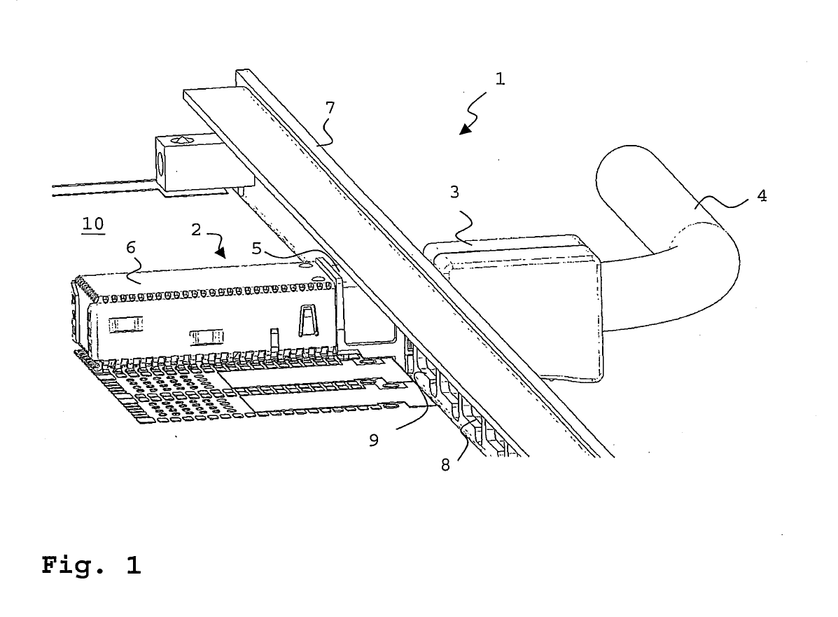

FIG. 1 shows a connector system according to an embodiment of the invention;

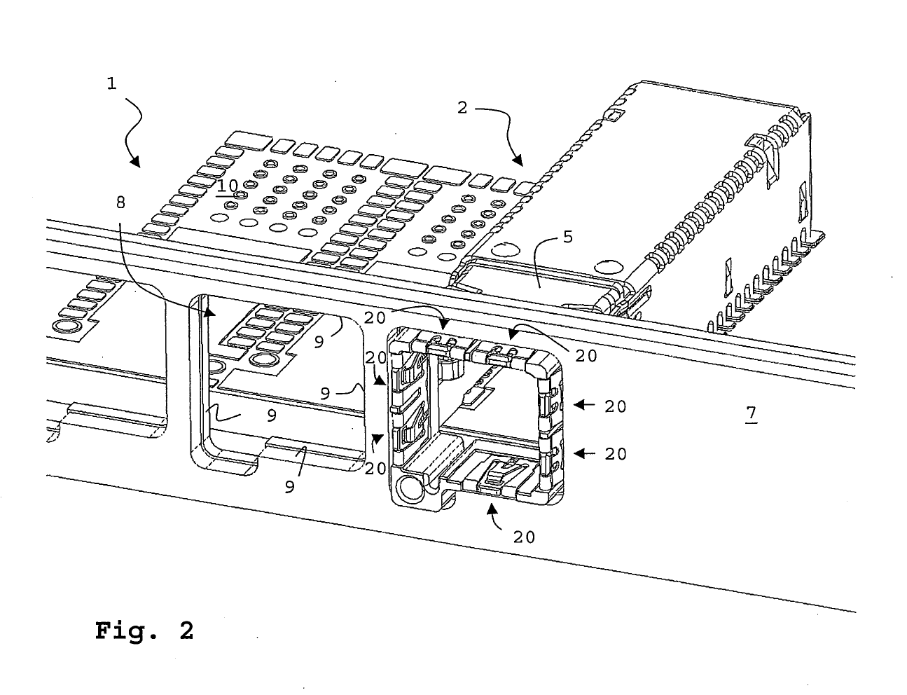

FIG. 2 shows a portion of the connector system of FIG. 1;

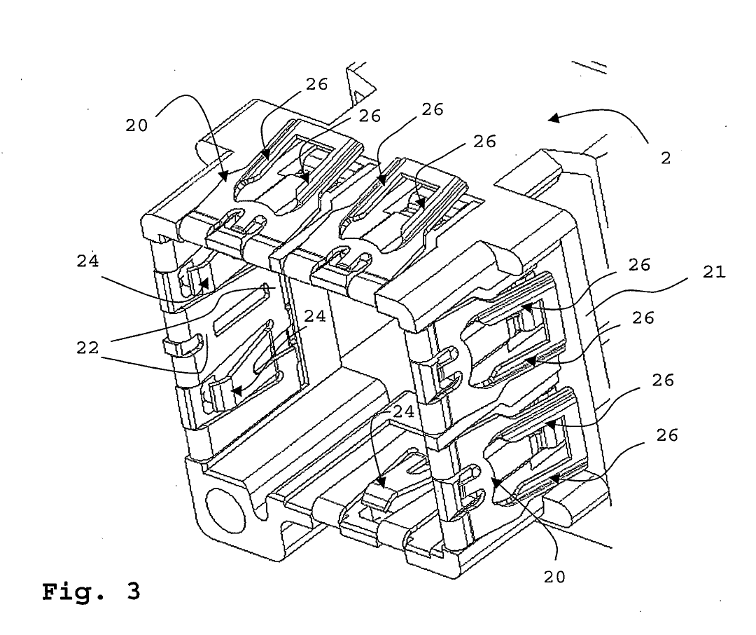

FIG. 3 shows a detailed image of a connector housing provided with contact elements according to an embodiment of the invention;

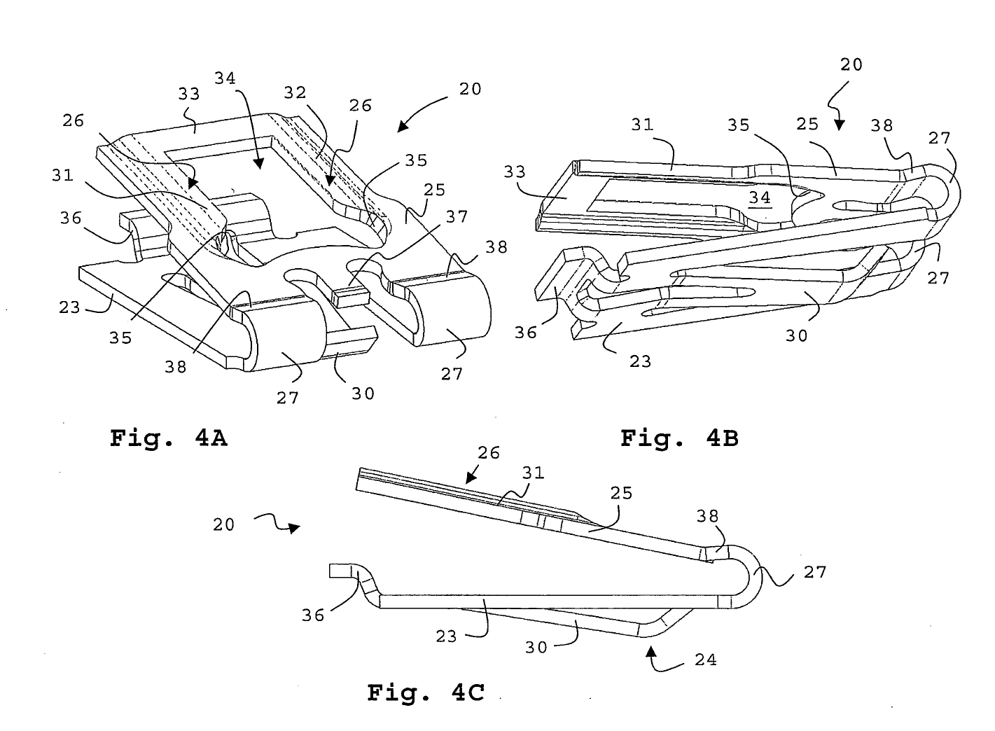

FIGS. 4A-4C show the contact element applied on the connector housing of FIG. 3;

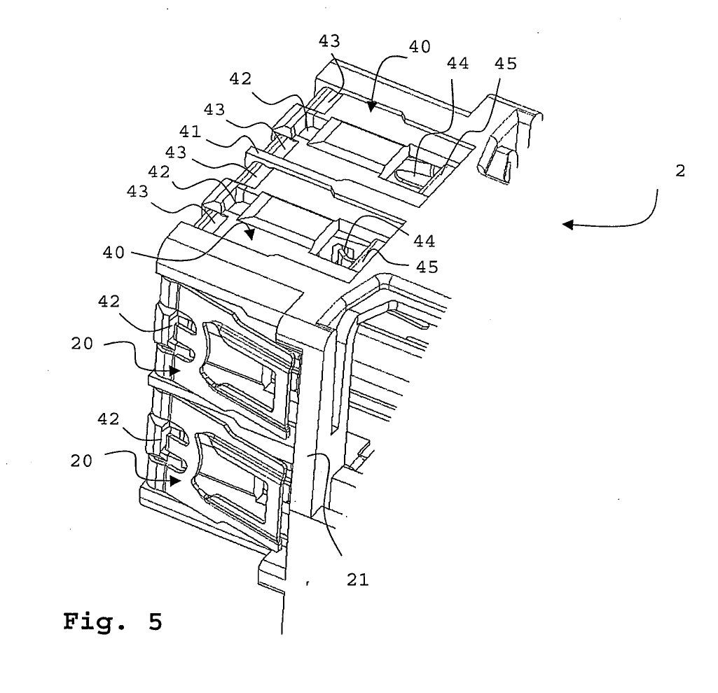

FIG. 5 shows a detailed image of a connector housing of FIG. 3 without some of the contact elements;

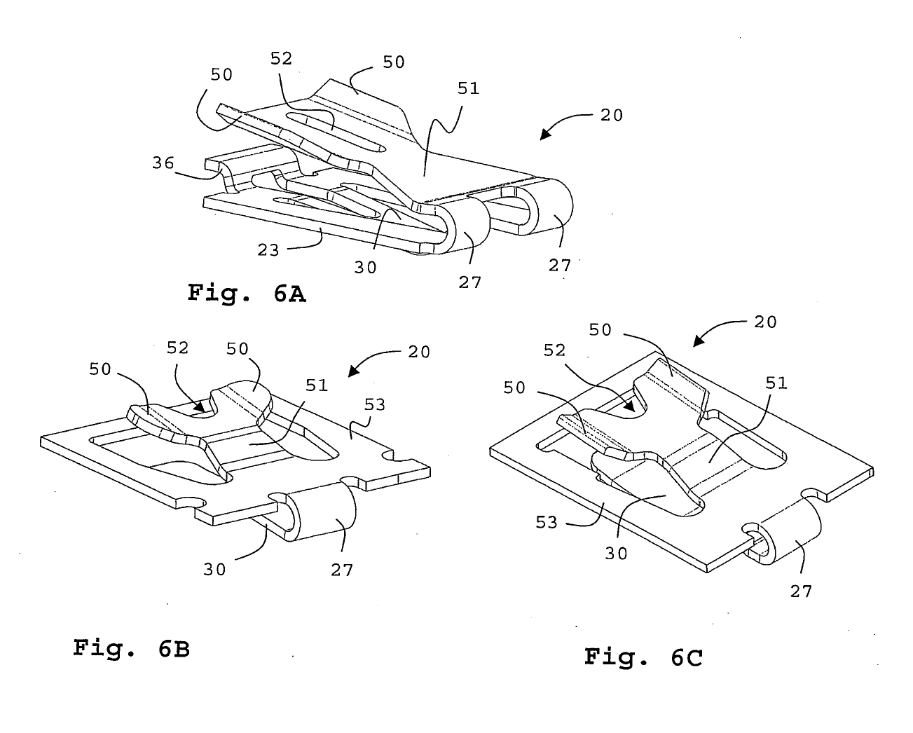

FIGS. 6A-6C show contact elements according to further embodiments of the invention, and

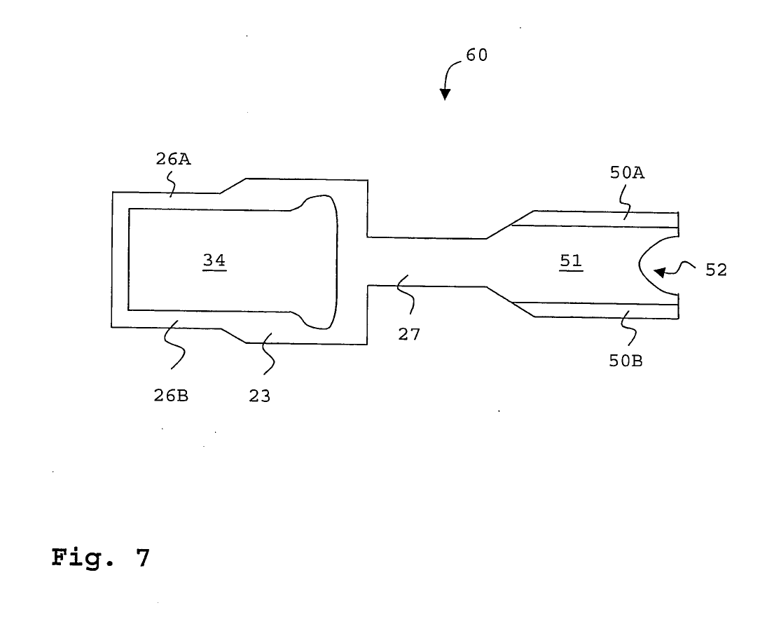

FIG. 7 shows a contact element in planar projection according to a still further embodiment of the invention.

In FIGS. 1 and 2 an I/O front-panel mounted connector system 1 is shown comprising a connector housing 2, capable of receiving a cable connector 3 of a cable 4. The connector housing or shielding cage 2 comprises a diecast metal portion 5 and a sheet metal portion 6. It should be noted that other types of connector housings fall within the scope of the present invention.

A panel 7 with openings 8 defined by edges 9 is attached to a circuit board or PCB 10. The PCB 10 generally comprises a plurality of signal tracks and electrical components (not shown) for the transmission of electrical signals to or from one or more wires of the cable 4. The connector housing 2 encapsulates a board connector (not shown) to connect to the cable connector 3 for said transmission of signals. This connection is realized by partly inserting the cable connector 3 through the opening 8 into the connector housing 2 until the cable connector 3 mates with the board connector.

As most clearly shown in FIG. 2, a front portion of the connector housing 2 (in this example a portion of the die-cast metal portion 5) protrudes through the panel 7 to receive the cable connector 3. The connector housing 2 has attached a series of contact elements 20 for contacting the panel 7 at the edges 9 of the opening 8 and the outer surface of the cable connector 3 if inserted in the opening 8. It is noted that the contact elements 20 are provided in electrically connected series for the upper and side walls of the connector housing 2 in the position shown. The lower wall has a single contact element 20.

FIG. 3 displays a detailed image of the front portion of the connector housing 2 provided with contact elements 20. FIGS. 4A and B show images of the contact element 20 in an unloaded state to be applied on the connector housing of FIG. 3 from two directions. FIG. 4C shows a cross-section of the contact element 20.

The connector housing 2 comprises shielding structures 21 at its side walls. The shielding structures 21 assist in the electromagnetic shielding performance of the connector system 1 when positioned behind the panel 7. However, as the connector system 1 typically is a high density connector system, the connector housing 2 may not allow the provision of such a shielding structure all around the connector housing 2. In the present embodiment, a shielding structure at the upper wall of the connector housing 2 is not suitable as this would increase the overall height of the connector housing 2. Accordingly, at this upper wall a shielding structure is absent and the contact elements 20 are the main elements to provide the electromagnetic shielding.

The contact elements 20 may be connected by connection means, such as a joining bridge 22, for walls of the connector housing 2 that allow more than one contact element 20. Manufacturing of the contact elements 20 may be performed in strips with multiple contact elements 20 stamped from a metallic sheet. These strips may be cut to length at the joining bridge 22 to provide the required number of contact elements 20 for attachment to a wall of the connector housing 2.

The contact elements 20 each have a first portion 23 structured to define a first group of electrical contacts 24 at a first surface of a wall of the connector housing 2 and a second portion 25, structured to define a second group of electrical contacts 26 at a second surface, opposed to the first surface, of this wall of the connector housing 2. The first portion 23 and second portion 25 are electrically coupled via at least one bended portion 27. The bended portion 27 makes the second portion 25 spring action loadable if a force is applied on this portion. The structure of the contact element 20 allows accommodation within a small space, which is particularly relevant for high density systems.

The first group of electrical contacts, which only consists of a single electrical contact 24 in this embodiment, is obtained from a spring loadable beam 30 capable of providing spring force action against the cable connector 3. When the cable connector is inserted into the opening 8 of the panel 7, the beam 30 develops a contact pressure against the cable connector to guarantee an appropriate electrical contact. Accordingly, leakage currents from the shielding of the cable 4 can be conducted to the system ground via the panel 7 and also directly to the PCB 10 via the connector housing 2. The number of such contacts 24 is preferably determined by the electrical resistance of each electrical contact 24 and the minimum required overall resistance of the contacts 24 arranged in parallel. Typically, this minimum overall resistance is in the range of 10-50 mΩ.

The second group of electrical contacts 26 of the contact element 20 is provided by a first beam 31 and a second beam 32. The first beam 31 and second beam 32 define two electrical contacts 26 of the second group. Accordingly, the contact element 20 is structured to provide a larger number of contacts 26 for the second group than the number of contacts 24 for the first group. In the present embodiments the ratio of second contacts 26 to first contacts 24 is 2:1. It is the observation of the inventors that the second group of contacts 26 is most important for the electromagnetic shielding performance of the connector system 1, such that a larger number of these contacts 26 is advantageous. The electrical contacts 26 may substantially close the space between the connector housing 2 and panel 7 to improve the electromagnetic shielding performance of the connector system 1 in comparison with the prior art system. In the present embodiment, the number of electrical contacts 26 is doubled in comparison to the prior art system.

It is noted that the distance between the first beam 31 and a second beam 32 is preferably substantially equal to the distance between the second beam 32 and the first beam 31 of an adjacent contact element 20 in order to provide optimal electromagnetic shielding. The latter distance can be obtained by controlling the connection means 22.

In order to optimise the performance of the contact elements 20, the structure of this element as shown in FIGS. 4A-4C is particularly advantageous. The first beam 31 and second beam 32 are coupled by a connection beam 33 to define a hole 34 in the second portion 25. The hole 34 comprises ears 35 at the side opposed to the connection beam 33. Further features of the contact element 20 include the support structure 36, constituted by a hook, in the first portion 23, and a latch 37 and support surface 38 in the second portion 25 of the contact element 20.

A particularly advantageous feature of the contact element 20 involves the independent flexing capability of the first portion 23 and the second portion 25. More particularly, the beam 30 may be operated without substantially influencing the orientation of the second portion 25, in particular the beams 31, 32, and vice versa. This may be accomplished e.g. by positioning the spring loadable beams such that, for an unfolded contact element 20, the spring loadable beams of the first and second portion do not both coincide with an imaginary straight line along the unfolded contact element 20. In the present embodiment, the bended portions 27 are located each on an imaginary line different from the location of the beam 30.

FIG. 5 again shows the connector housing 2 of FIG. 3, but without the contact elements 20 attached on the upper wall to illustrate the accommodation structure of the connector housing 2 for the contact elements 20.

The upper wall comprises structured recesses 40 at the outside to accommodate one or more contact elements 20. The recesses 40 are separated by a division wall 41. Each recess 40 has a locking structure, e.g. a hole 42, substantially in the middle of the recess 40. The hole 42 may also provide clearance for the first contact beam 24 of the first portion 23. Near the edges of the recess 40, a recessed support area 43 is defined. Further, a combination of a hole 44 and a surface 45 is provided at the rear side of the recess 40. The contact elements 20 are attached to the walls of the connector housing 2 by the bended contact element 20 from the front side, such that the first portion 23 is within the connector housing 2 and the second portion 25 remains outside of the housing. The hook 36 is inserted from the inside of the housing 2 through the hole 44, such that a hook portion rests on the surface 45 at the rear side of the recess 40. The tuned dimensions and structure of the contact element 20 and recess 40 allow the latch 37 to snap into the locking structure 42 in a position wherein the support surface 38 of the contact element 20 coincides with the recessed support area 43.

The operation of the connector system 1 is as follows. The connector housing 2, provided with the contact elements 20 as shown in FIG. 3, is inserted from the back side of the panel 7 through the hole 8, such that a front portion protrudes through the panel 7 as shown in FIG. 2. During this operation, a spring force builds up in the second portion 25 of the contact element by the interaction of the contact element 20 with the edges 9 of the hole 8 in the panel 7. The reaction force is transferred over the bended portion 27 towards the hook 36 of the first portion 23 where it is counterbalanced by the surface 45. Consequently, the beams 31, 32 define two electrical contacts 26 between the connector housing 2 and the panel 7.

The cooperation of the support surface 38 and the recessed support area 43 defines a clear location over which elastic deflection of the second portion 25, in particular of the beams 31, 32, occurs. The recessed area further allows compensation for tolerances in the dimensions of the contact element 20.

The beams 31, 32 and the shape of the hole 34, in particular the ears 35, are arranged such that the beams 31, 32 may deflect with respect to each other to a certain extent in order to compensate for alignment tolerances in the connector system 1. Causes of misalignment include inadequately defined edges 9 of the openings 8 in the panel 7, residue stresses, especially torsion, in the contact element 20 as a result of the manufacturing process, e.g. stamping, of the contact element 20 and irregular surfaces of the connector housing 2. Such misalignment causes can be compensated for by relative motion of the two beams 31, 32. This motion is facilitated by the upwardly curved nature of the beams 31, 32 from the plane of the second portion 25 towards the connection beam 33 in the direction of the hole 34 over at least a part of the beams 31, 32. Consequently, both electrical contacts 26 can be established with increased certainty for a single contact element 20, even if e.g. the edges 9 are less accurately defined.

When the connector housing 2 is in position, the second portion 25 is accommodated to a large extent in the recesses 40, such that separated electrical contacts 26 are made with the edges 9. Subsequent insertion of the cable connector 3, wherein the first contacts 24 contact the cable connector, does not influence these second electrical contacts 26 as the structure of the contact element 20 is such that the first portion 23 and second portion 25 operate independently from each other.

It should be appreciated that the connector system 1 and contact element 20 as described above are embodiments of the invention and may be varied within the scope of the present invention. As an example, FIGS. 6A-6C show other embodiments of a contact element, wherein the second portion 25 defines the second group of electrical contacts 26 by providing extensions or wings 50 extending from a single spring loadable beam 51 of the second portion 25. The beam 51 has a cut-away portion 52 positioned at least partly between the wings 50 to allow relative flexibility between the wings. It is noted that the beams 30 and 51 do influence each other in the embodiments shown in FIGS. 6B and 6C, since they are in line with each other. Further, in these embodiments, the beams 30 and 51 extend from a planar section 53.

It should further be appreciated that the contact element 20 as displayed in the previous Figs. is particularly suitable for high density connector systems. However, if e.g. sufficient space is available for an increased amount of first contacts 24, both the first portion 23 and second portion 25 may have at least two contacts.

This is schematically illustrated in FIG. 7, wherein a contact element 60 is shown in planar projection in an unfolded state. Basically the first portion 51 has contacts 50A, 50B in an arrangement similar to the beam displayed in FIG. 6C, whereas the second portion 25 has contacts 26A, 26B in an arrangement similar the second portion 25 with the hole 34 displayed in FIGS. 4A and 4B. The increased number of contacts for the first portion 51 may decrease the overall electrical resistance for carrying leakage currents as discussed above. It should be noted that the number of contacts may also be larger than two for either the first portion 51 or second portion 26 of the contact element 60.

1. A connector system comprising a connector housing, capable of receiving a cable connector, and a panel, said panel having at least one opening defined by edges of said panel, from which opening at least a front portion of said connector housing protrudes to receive said cable connector and wherein at least one contact element is provided, capable of electrically coupling said connector housing and said cable connector by a first group of electrical contacts and electrically coupling said connector housing and said panel by a second group of electrical contacts. characterized in that said contact element is structured to provide at least two separate electrical contacts for said second portion.

2. The connector system according to claim 1, wherein said contact element is structured to provide a larger number of contacts for said second group than for said first group.

3. The connector system according to claim 2, wherein the ratio of electrical contacts of said second group to said first group is 2:1 or higher.

4. The connector system according to claim 1, wherein said contact element comprises a first portion, structured to define said first group of electrical contacts at a first surface of a wall of said connector housing and a second portion, structured to define said second group of electrical contacts at a second surface, opposed to said first surface, of said wall.

5. The connector system according to claim 4, wherein said first portion and second portion are electrically coupled via at least one bended portion.

6. The connector system according to claim 4, wherein at least one of said first portion and second portion comprise at least one spring loadable beam capable of providing spring force action against said cable connector and said edges of said opening to define said first group and second group of electrical contacts.

7. The connector system according to claim 6, wherein said spring loadable beams are positioned to allow substantially independent operation of said beams of said first portion and second portion.

8. The connector system according to claim 4, wherein said second portion comprises a first beam and a second beam defining electrical contacts of said second group and said contact element is adapted to provide spring force action of said first and second beam against said edges of said opening.

9. The connector system according to claim 8, wherein said first beam and second beam are coupled by a connection beam to define a hole in said second portion, wherein said hole comprises ears at the side opposed to said connection beam.

10. The connector system according to claim 1, wherein said contact element comprises a support structure and said connector housing comprises a further structure capable of cooperating with said support structure to absorb forces exerted on said second group of electrical contacts.

11. The connector system according to claim 1, wherein said contact element comprises at least one latch to lock said contact element on said connector housing.

12. The connector system according to claim 1, wherein said connector housing comprises shielding structures positioned behind said panel.

13. A contact element comprising a first portion and a second portion coupled via at least one bended portion, defining a first group of electrical contacts for said first portion and a second group of electrical contacts for said second portion characterized in that said contact element is structured to provide at least two separate electrical contacts for said second portion.

14. The contact element according to claim 13, wherein said first portion and second portion comprise spring loadable beams defining said first group of electrical contacts for said first portion and said second group of electrical contacts for said second portion.

15. The contact element according to claim 14, wherein said spring loadable beams are positioned to allow substantially independent operation of said beams of said first portion and second portion.

16. The contact element according to claim 13, wherein said contact element is structured to provide a larger number of contacts for said second group of contacts than for said first group of contacts.

17. The contact element according to claim 13, wherein said second portion comprises a first beam and a second beam defining electrical contacts of said second group.

18. The contact element according to claim 17, wherein said first beam and second beam are coupled by a connection beam to define a hole in said second portion, wherein said hole comprises ears at the side opposed to said connection beam.

18. The contact element according to claim 13, wherein said second portion has a single spring loadable beam with at least two extensions capable to determine at least two separate electrical contacts.

19. The contact element according to claim 18, wherein said spring loadable beam has a cut-away portion defined at least partly between said extensions.

20. The contact element according to claim 13, wherein said contact element is further structured to provide at least two separate electrical contacts for said first portion.
